(19) United States
(12) Patent Application Publication
(10) Pub. No.: US 2009/0070255 A1
(43) Pub. Date: Mar. 12, 2009

(54) Social lending and borrowing in virtual financial community

(76) Inventor: Durga Ramana Muktevi, Fremont, CA (US)

Correspondence Address: Ashok Tankha;Of Counsel, Lipton, Weinberger & Husick, 36 Greenleigh Drive, Sewell, NJ, 08080, US

(21) Appl. No.: 11/899,723

(22) Filed: Sep. 7, 2007

(51) Int. Cl. G06Q 40/00

(52) U.S. Cl. 705/39

(57) ABSTRACT

Disclosed herein is a computer implemented method for creating and maintaining a virtual financial community with a plurality of subscribers subscribing to a social lending and/or borrowing scheme. A total face value and a scheme period are specified for the scheme. Each subscriber periodically invests a predetermined portion of the total face value until the end of the scheme period. A beneficiary subscriber is democratically elected for borrowing an amount equal to the total face value at the end of each investment period. The beneficiary subscriber may relinquish a percentage of the borrowed amount that is democratically decided by the subscribers and/or the scheme moderator. The percentage of the amount relinquished by the beneficiary subscriber is distributed between the non beneficiary subscribers and the scheme moderator. The steps of electing and distributing are repeated for each of the predefined periodic intervals until the end of the scheme period.

### BACKGROUND

Financial institutions such as credit companies loan money or offer credit amounts to consumers which the consumer can “resolve” or repay with interest on the amount borrowed. The credit balance of the consumer generally has to be paid back in full before a grace period that usually ranges between 20 to 45 days. After the grace period, the credit companies usually impose high interest rates on the balance amount. Several other credit and loan schemes are offered, but these schemes have their own limitations and disadvantages. For example, subprime lending is risky for both the borrowers and lenders due to high interest rates, and poor credit history often associated with subprime applicants. Adjustable rate mortgages (ARM) are an inherent risk to a borrower, as interest rates can be changed or adjusted during the term of the loan.

Investment schemes may offer limited returns, and stocks may yield limited dividends to investors for their investments. Even long term investments may involve an element of investment risk in terms of capital loss.

Thus, there is a need for a method and system that allows groups and individuals to form a social lending and/or borrowing scheme. The scheme should not impose an instant financial burden on the borrower, while rewarding investors who retain their investments to full-term or near full-term with attractive returns. The method and system should take advantage of the existing computer network infrastructure and the World Wide Web for the convenience of members of the scheme.

### SUMMARY OF THE INVENTION

Disclosed herein is a computer implemented method for creating and maintaining a virtual financial community, wherein the virtual financial community comprises a plurality of subscribers subscribing to a social lending and/or borrowing scheme. A total face value and a scheme period are specified for the scheme by a scheme moderator. The scheme period may comprise a number of predefined periodic intervals. Each of the subscribers invests a predetermined portion of the total face value for each of the predefined periodic intervals until the end of the scheme period. A beneficiary subscriber is democratically elected at the end of each of the predefined periodic interval. The beneficiary subscriber may be nominated amongst the subscribers for borrowing an amount equal to the total face value from the investments of all the subscribers. The beneficiary subscriber may have to relinquish a percentage of the amount borrowed. The percentage of the borrowed amount that the beneficiary subscriber may have to relinquish is democratically decided by the subscribers and/or the scheme moderator. The percentage of the amount relinquished by the beneficiary subscriber is distributed as dividend between the non-beneficiary subscribers and the scheme moderator. The steps of electing a beneficiary subscriber and distributing returns are repeated for each of the predefined periodic intervals until the end of the scheme period. A different beneficiary subscriber is elected at the end of each of the predefined periodic intervals to borrow an amount equal to the total face value, and no subscriber is elected a second time as the beneficiary subscriber in the particular scheme.

Disclosed herein is a method and system to create a self funded virtual user community for short term loans. The participants in the community may comprise already established members of peer-to-peer lending network of communities. The communities are formed virtually through social networking among professional and industrial organizations, individuals, people involved in the same group and their website, and email groups. The virtual communities may also be formed by partnering with members of financial institutes, banks, cooperative and credit unions, professional clubs, employee social unions, home owner associations, common interest groups, online e-groups, and groups of people from industrial firms, organizations, and educational institutions, etc.

The method disclosed herein takes advantage of computer, internet, software, telephone, hardware and data technologies. A number of other virtual financial communities may be created and integrated into the virtual financial community using service oriented architecture, e-commerce technologies such as business-to-business (b2b), business-to-consumer (b2c), consumer-to-consumer (c2c), enterprise service bus, web services, soap messages, web description services language (WSDL), universal description discovery and integration (UDDI), internet and intranet protocols, other wide area networks (WAN), secure transactions, cryptography, and other modern technologies.

The system disclosed herein creates a community portal for financial needs. People can self-finance for their monetary needs from the participants of the virtual financial communities. The social lending and borrowing model may guarantee return of the short tem loans and rewards to the community members. These virtual financial communities for financial self-help can be formed from various other virtual communities. Members of multiple virtual communities can join a single virtual community to obtain and/or raise short term loans. The method disclosed herein provides a method and system to create a business and technology platform for self and social lending/borrowing financial company/model where various virtual communities, credit unions, cooperative unions, etc. can venture/participate in both wholesale and retail.

The virtual financial community disclosed herein for illustrative purposes includes, but is not restricted to, wealth exchanges, financial clubs, financial institutions, wealth organizations, social financial communities, community lending groups, etc., wherein the computer implemented method disclosed herein may be implemented for lending and borrowing schemes.

### BRIEF DESCRIPTION OF THE DRAWINGS

The foregoing summary, as well as the following detailed description of the embodiments, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method of creating and maintaining a virtual financial community comprising a plurality of subscribers subscribing to a social lending and/or borrowing scheme.

FIG. 2 illustrates a system for creating and maintaining a virtual financial community.

FIG. 3 illustrates an exemplary scheme where a beneficiary subscriber is democratically selected.

FIG. 4 exemplary illustrates a scheme model with one beneficiary subscriber for each of the predefined periodic intervals.

FIG. 5 exemplary illustrates a scheme model with more than one beneficiary subscriber for each of the predefined periodic intervals.

FIG. 6 illustrates a high level overview of the virtual financial community.

FIG. 7 illustrates a statistics chart of an exemplary scheme.

FIG. 8 exemplary illustrates the projected revenues for a large scale scheme moderator firm.

FIG. 9 exemplarily illustrates a plurality of marketing channels for promoting the social lending/borrowing schemes.

### DETAILED DESCRIPTION OF THE DRAWINGS

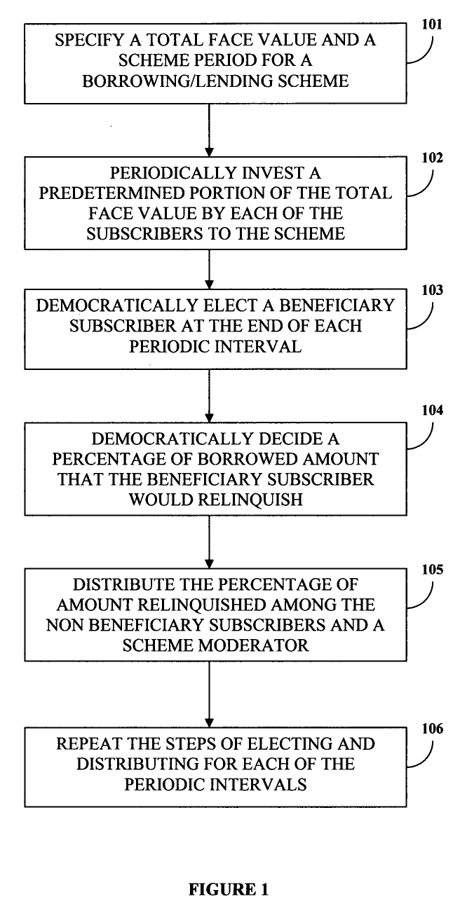

FIG. 1 illustrates a computer implemented method of creating and maintaining a virtual financial community comprising a plurality of subscribers subscribing to a social lending and/or borrowing scheme. A total face value and a scheme period are specified for the scheme 101 by a scheme moderator. The scheme period may comprise a number of predefined periodic intervals. Each of the subscribers invests a predetermined portion of the total face value for each of the predefined periodic intervals 102 until the end of the scheme period. A beneficiary subscriber is democratically elected at the end of each of the predefined periodic interval 103. The beneficiary subscriber may be nominated amongst the subscribers for borrowing an amount equal to the total face value from the investments of all the subscribers. The beneficiary subscriber may have to relinquish a percentage of the amount borrowed. The percentage of the borrowed amount that the beneficiary subscriber may have to relinquish is democratically decided by the subscribers 104 and/or the scheme moderator in set period of time. The percentage of the amount relinquished by the beneficiary subscriber is distributed as dividends or returns between the non-beneficiary subscribers and the scheme moderator 105. The steps of electing a beneficiary subscriber and distributing dividends or returns are repeated for each of the predefined periodic intervals 106 until the end of the scheme period. A different beneficiary subscriber is elected at the end of each of the predefined periodic intervals to borrow an amount equal to the total face value, and no subscriber is elected a second time as the beneficiary subscriber in the particular scheme.

For example, Y subscribers may invest a default monthly amount of $X to form a pool of money every month. The amount that is pooled each month is $X*Y subscribers *Z days=$xyz. On a set day and time, for example at the end of the predefined periodic interval, the X subscribers may democratically elect a beneficiary subscriber, or any particular subscriber volunteer(s), by nominating among themselves and benefiting the subscriber to take the pool of money, i.e., $xyz. The nominated beneficiary subscriber in return relinquishes $W which may be mutually agreed upon all members out of $xyz in a set period of time, wherein $W is distributed among the virtual financial community members, i.e., the subscribers of the scheme and the scheme moderator. The amount that the beneficiary subscriber would have to relinquish ($W) is decided democratically among the virtual financial community members. The scheme moderator obtains V % of the relinquished amount ($W) and/or a U % of $xyz for providing the technical platform and business know-how to the virtual financial community for Z days.

The number of predefined periodic intervals in the scheme period may be equal to the number of subscribers to the scheme. In an embodiment of the invention, more than one beneficiary may be declared for each of the predefined periodic intervals. The number of beneficiary subscribers for each of the predefined periodic intervals may be specified by the scheme moderator. Further, the scheme period is determined as a ratio of the number of subscribers to the number of beneficiary subscribers for each of the predetermined periodic intervals.

A subscription value is determined for the scheme, wherein the subscription value is the ratio of the total face value to the number of subscribers. Hence, the predetermined portion of the total face value that a subscriber invests every periodic interval is the difference of the subscription value and the portion of the relinquished amount distributed to each subscriber for the particular periodic interval.

The scheme moderator may deal with multiple virtual financial communities in wholesale and may perform checks on subscriber/customer diligence and backgrounds. The scheme moderator may provide security to the participant subscribers by providing insurance on their deposits and limited guarantee on their returns as rewards, money or benefiting with less money in times of need.

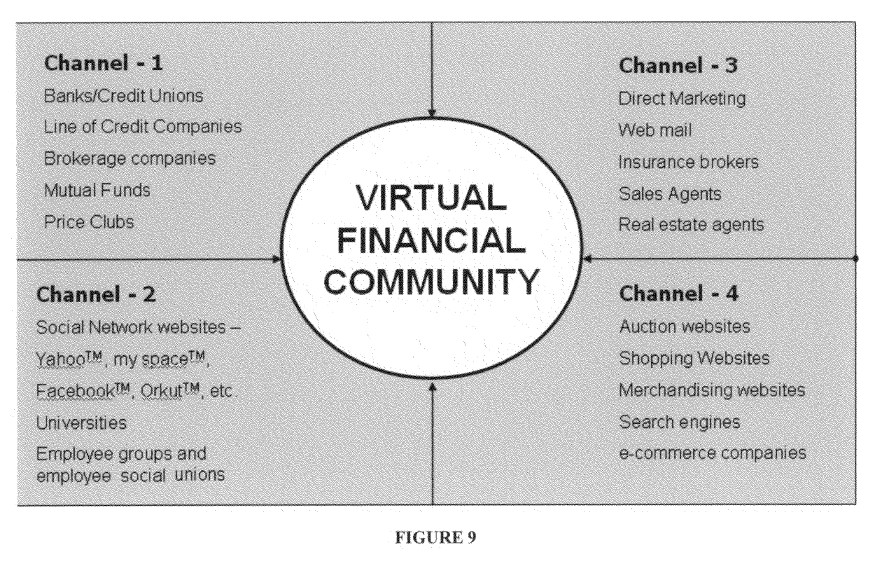

Virtual financial communities may be formed by partnering with members of credit unions, professional clubs, employee unions, home owner associations, and groups of people from industrial firms and educational institutions. Any business, corporation or financial institution may become a member of an existing virtual financial community. The schemes available for potential virtual financial communities and subscribers may be promoted through several marketing channels as illustrated in FIG. 9. The schemes are promoted by the services of promoting and marketing partners such as financial institutions, social networking websites, online auction websites, and direct marketing through dedicated websites of the scheme moderator firm, telephone systems, or in person in an assigned place. The promoting financial institutions may comprise banks, credit unions, line of credit companies, brokerage companies, mutual fluds, price clubs, etc. The online auction websites may comprise service websites provided by PayPal™, eBay ™, Ubid ™, Google ™, etc. Direct marketing and other agents may comprise brokers of insurance agents, real estate agents, etc.

Virtual financial communities may be formed based on the credit scores, risk and worthiness obtained from credit bureaus, repayment capacities of the community members, and individual member assurance or guarantee. Large scale virtual financial communities may be formed by promoting the schemes on a large scale through the marketing and promoting partners. In an embodiment of the invention, existing members of peer-to-peer lending network of communities may be incorporated into the virtual financial communities.

In another embodiment of the invention, members of one virtual financial community may lend money to members of another virtual financial community. This kind of inter-community lending may be performed using social virtual peer to virtual peer (SVP-TO-SVP) lending/borrowing schemes and by democratically setting the interest rates. The scheme moderator may obtain a predetermined percentage of the imposed interest rates.

A number of virtual financial communities may be created and integrated into a single virtual financial community using service oriented architecture, enterprise service bus, web services, soap messages, protocols, web description services language (WSDL), universal description discovery and integration (UDDI), secure transactions, cryptography, and other modern technologies. The scheme moderator may automate several functioning aspects of the virtual financial community using promoting partner tools and websites. For example, the subscribers may be provided an option of democratically electing the deductions before the set date, i.e. before the end of the predefined periodic interval, so that the subscribers do not have to be present on the particular day. The subscribers may chose an option such that the system may take pseudo decisions on incrementing and decrementing the relinquish on preset amounts, so that the subscribers do not have to participate during the pool day and time. The subscribers may set and forget their relinquish, which will trigger automatically on pool day. The subscribers may link up checking/savings accounts instead of credit card transaction fees charges. Also, the system may automatically generate the applicable government income tax forms for returns of each of the subscribers and/or for the virtual financial communities. The system may report to the government and credit bureaus of the revolving pool amount, and to collections agencies about delinquencies and recoveries.

In an embodiment of the invention, the identity of the members or subscribers is not disclosed to the other members or subscribers for maintaining privacy. In another embodiment of the invention, multiple virtual members may form a group and participate as a single member to raise the default monthly investment amount. In another embodiment of the invention, loans may be provided against the pool money in advance to a non-beneficiary subscriber.

In another embodiment of the invention, goods such as jewelry, mutual funds, stocks, house hold items may be purchased in whole sale or discounted prices by taking advantage of financial strength of the virtual financial community.

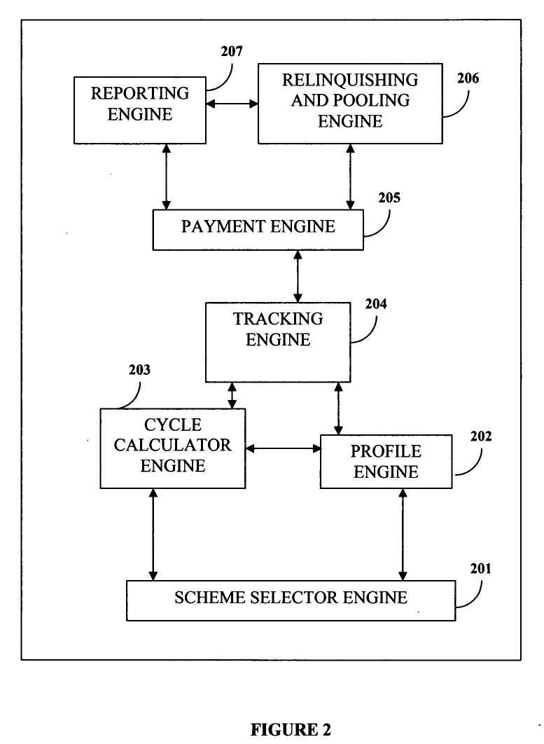

FIG. 2 illustrates a system for creating and maintaining a virtual financial community. A scheme selector engine 201 specifies a total face value and a scheme period for each scheme. A cycle calculator engine 203 specifies the number of predefined periodic intervals or cycles in the scheme period of each scheme. A profile engine 202 creates and maintains subscriber profiles associated with each scheme. A tracking engine 204 tracks the investments and dividends of each of the subscribers for each of the predefined periodic intervals until the end of the scheme period. A relinquishing and pooling engine 206 is used for democratically electing a beneficiary subscriber at the end of each predefined periodic interval. The subscribers nominate and elect beneficiary subscribers through partner websites, electronic mails, telephone calls, and other partner services. The relinquishing and pooling engine 206 collects democratically decided relinquish and pool data and declares the beneficiary subscriber. A reporting engine 207 reports the pool amount, the relinquish amount and percentages data to the subscribers and the scheme moderator. The subscribers and the scheme moderator obtain information about their rewards, gain harvest, etc., from these reports. A payment engine 205 is used to distribute the amount relinquished by the beneficiary subscriber to the non-beneficiary subscribers and the scheme moderator. The payment engine 205 releases the borrowed amount to the beneficiary subscriber after deducting an amount that the beneficiary subscriber is willing to relinquish.

In case an invitation for democratically selecting the nominee and the relinquish amount is made, the pool engine 206 is used to collect the nominees and the decisions on the relinquish amount, and to determine a winner, i.e., a beneficiary subscriber. The scheme selector engine 201 is used to specify the number of beneficiary subscribers for each of the predefined periodic intervals in each scheme. The scheme selector engine 201 also determines a subscription value for each scheme as the ratio of the total face value of the scheme to the number of subscribers. The cycle calculator engine 203 calculates the scheme period as a ratio of the number of subscribers to the number of beneficiary subscribers for each of the predetermined periodic intervals or cycles.

The system of the present invention creates a community portal for financial needs that allows the members to access the portal through the web and view their profiles, information on investments and dividends, blogs of other communities and their percentages of rewards and relinquishments. The members are provided with options to maintain privacy about their identities from other members. People can self-finance their monetary needs from the participants of these communities. Portal members or subscribers can take advantage of the large user based community and share the wealth among the virtual communities. The social lending and borrowing model may guarantee return of the short term loans and rewards to the community members. These virtual financial communities for financial self-help can be formed from various other virtual communities. Members of multiple virtual communities can join a single virtual community to obtain and/or raise short term loans. The system creates a business and technology platform for self and social lending/borrowing financial company/model where various virtual communities, credit unions, cooperative unions, etc., can venture or participate in both wholesale and retail.

In an embodiment of the invention, a beneficiary subscriber may be selected by an auction conducted amongst the subscribers at the end of each predefined periodic interval for an amount equal to the total face value. A subscriber bidding a sum that relinquishes the highest percentage of the amount wins the bid and is considered the beneficiary subscriber.

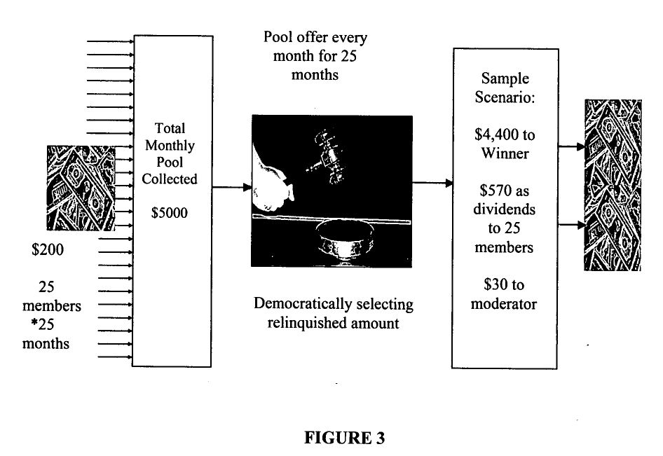

FIG. 3 illustrates an exemplary scheme wherein a beneficiary subscriber is democratically selected. For example, consider a scheme where the total face value of the scheme is $5000, which is the product of the number of predefined periodic intervals (months) in the scheme period, i.e., 25 months and the predetermined total face value that the subscriber invests every month, i.e. $200. The democratic selection is carried out each month for the $5000 (25 subscribers*$200=$5000) pooled in the particular month for the scheme period of 25 months. A subscriber bidding a sum that relinquishes the highest percentage of $5000 wins the bid for the month. The subscriber, in this example relinquishes $600 in the bid. This $600 is distributed amongst the subscribers and the scheme moderator, herein Srivard.

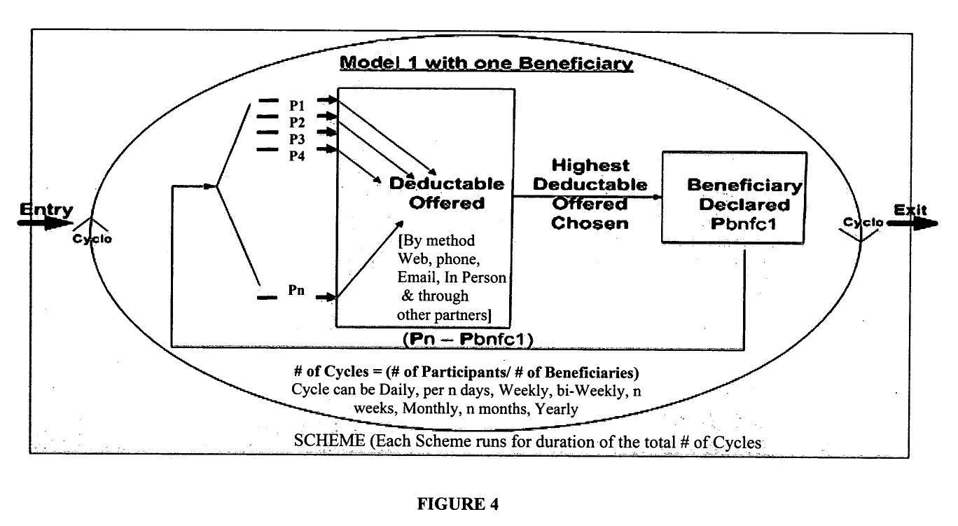

FIG. 4 exemplary illustrates a scheme model with one beneficiary subscriber for each of the predefined periodic intervals. The predefined periodic intervals constitute cycles of periodic investments and democratic selections or auctions for selecting the subscriber beneficiaries, as illustrated in FIG. 4. Each cycle may be repeated periodically, for example, every day, every n number of days, every week, every n number of weeks, every month, every two months, every year, etc., depending on the scheme model. With one beneficiary subscriber in each cycle, the number of cycles required in the scheme period is equal to the number of subscribers to the scheme. In the embodiment of the invention where an auction is conducted in each cycle for declaring a beneficiary subscriber, the subscriber offering the highest deductable or relinquish is declared the beneficiary subscriber. The system of the present invention allows subscribers to declare a beneficiary using the internet and other means. The subscribers may bid using auction websites, through electronic mail, telephone calls, or through other partner services.

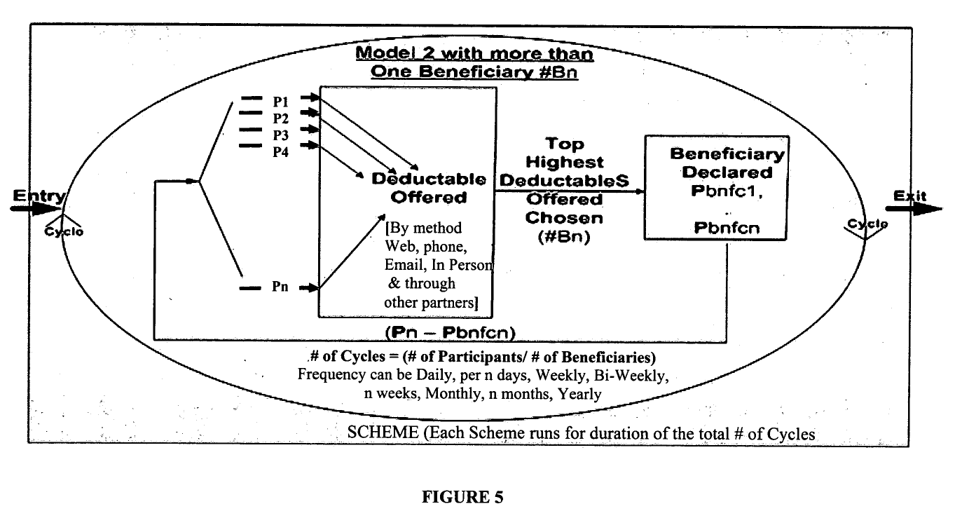

FIG. 5 exemplary illustrates a scheme model with more than one beneficiary subscriber for each of the predefined periodic intervals. With more than one beneficiary subscriber in each cycle, the number of cycles required in the scheme period may be equal to the ratio of the number of subscribers to the number of beneficiaries in each cycle. For example, if two beneficiary subscribers are declared in each cycle in a scheme with 24 subscribers, the number of cycles required may be a ratio of 24 to 2, which is equal to 12 cycles.

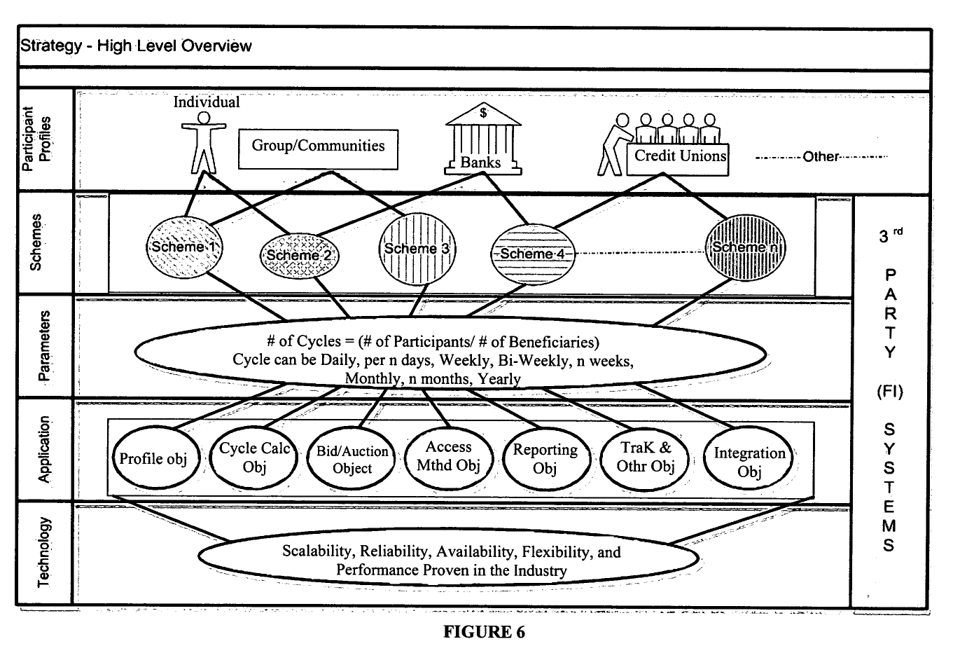

FIG. 6 illustrates a high level overview of the virtual financial community. The subscribers to the schemes may comprise individuals, group communities, banks, credit unions, etc. The subscribers may join more than one virtual financial community, and the subscribers and/or the virtual financial communities may subscribe to more than one scheme. The parameters such as the subscription value, the scheme period, the number of cycles, the number of beneficiary subscribers per cycle, etc., are determined for each scheme. Several application objects of the system process data related to the schemes and subscribers, determine parameters for the schemes, track data, perform reporting and integrating functions, collect and process relinquish and pool data, etc. The objects comprise profile object, cycle calculator object, relinquishing and pooling object, access method object, reporting object, track and other object, integration object, bid/auction object, etc.

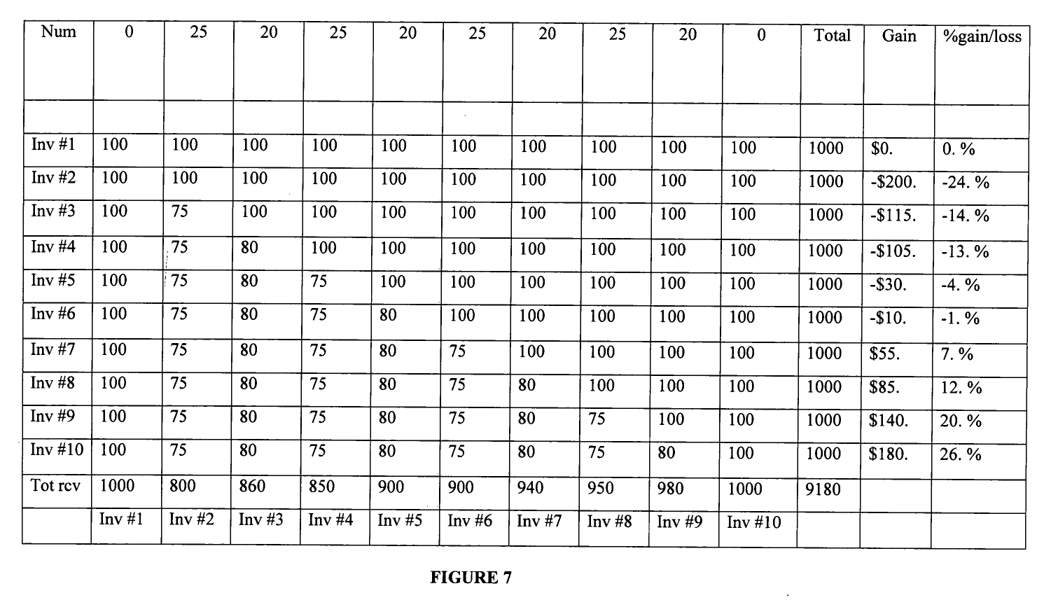

FIG. 7 illustrates an exemplary statistics chart for an exemplary scheme. The statistics presented in the chart of FIG. 7 are for illustration purposes only. Referring to the chart, a subscriber democratically selected in one of the earlier cycles of the scheme period loses a percentage of the investment. This is indicated by the negative percentage of gain/loss. As illustrated in the chart, investors 1 to 6 have negative percentage of gain/loss. However, subscribers democratically selected in one of the later cycles of the scheme period gain returns on their investment. This is indicated by positive percentage of gain/loss. As illustrated in the chart, investors 7 to 10 have positive percentage of gain/loss.

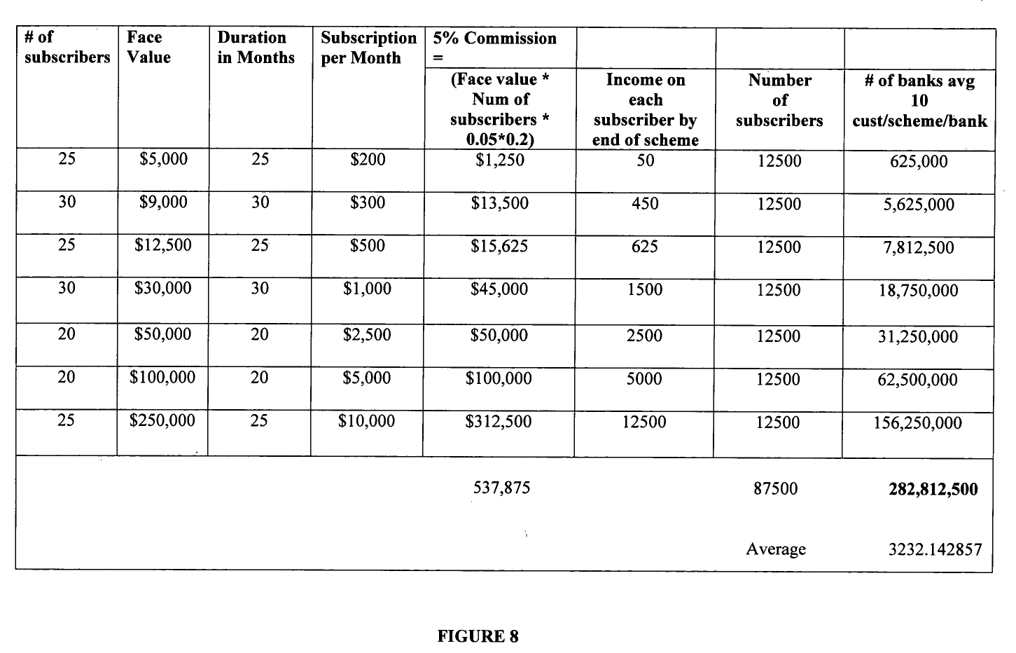

FIG. 8 exemplary illustrates the projected revenues for a large scale scheme moderator firm. The figures presented in the chart of FIG. 8 are for illustration purposes only. The chart indicates that a scheme moderator firm may earn substantial revenues with large-scale participation of subscribers and a plurality of schemes.

FIG. 9 exemplarily illustrates a plurality of marketing channels for promoting the social lending/borrowing schemes. The marketing channels comprise financial institutions, social networking websites and online e-groups, e-commerce websites and companies, direct marketing, etc. The financial institutions for promoting the schemes may comprise banks, credit unions, line of credit companies, brokerage companies, mutual funds, price clubs, etc. The social networking websites and online e-groups comprise websites such as yahoo ™, myspace ™, facebook ™, orkut ™, google ™, etc., and other groups of academic institutions, employee groups and employee social unions, etc. The e-commerce websites and companies comprise online auction websites such as PayPal™, eBay ™, Ubid ™, Google ™, etc., search engines, and other merchandising and shopping websites. Direct marketing agents may comprise insurance brokers, sales agents, real estate agents, etc.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A ‘processor’ means any one or more microprocessors, Central Processing Unit (CPU) devices, computing devices, super computers, microcontrollers, digital signal processors or like devices. The term ‘computer-readable medium’ refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, Visual Basic, or JAVA. The software programs may be stored on or in one or more mediums as an object code. A computer program product comprising computer executable instructions embodied in a computer-readable medium comprises computer parsable codes for the implementation of the processes of various embodiments.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, Sun® processors, AMD® processors, IBM® processors, etc. that are adapted to communicate with the computer. Any number and type of machines may be in communication with the computer. Also, the entire process can be processed and performed in data centers.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A computer implemented method of creating and maintaining a virtual financial community comprising a plurality of subscribers subscribing to a social lending and/or borrowing scheme, said method comprising the steps of:
specifying a total face value and a scheme period for said scheme by a scheme moderator, wherein said scheme period comprises a number of predefined periodic intervals;
investing a predetermined portion of said total face value by each of said subscribers for each of said predefined periodic intervals until the end of the scheme period;
democratically electing a beneficiary subscriber at the end of each predefined periodic interval by nominating said beneficiary subscriber amongst the subscribers, wherein the beneficiary subscriber borrows an amount equal to the total face value;
democratically deciding a percentage of said amount that the beneficiary subscriber would relinquish;
distributing said percentage of the amount relinquished by said beneficiary subscriber between the non beneficiary subscribers and said scheme moderator; and
repeating said steps of electing, and distributing for each of the predefined periodic intervals until the end of the scheme period.

2. The computer implemented method of claim 1, wherein a beneficiary subscriber is selected by democratically deciding the relinquish amount amongst the subscribers at the end of each predefined periodic interval.

3. The computer implemented method of claim 1, wherein said number of predefined periodic intervals in said scheme period is an appropriate ratio to the number of subscribers to the scheme.

4. The computer implemented method of claim 1, further comprising promoting and marketing partners for the scheme.

5. The computer implemented method of claim 4, wherein said promoting and marketing partners comprises financial institutions, social networking websites, online auction websites, direct marketing, and agents.

6. The computer implemented method of claim 1, further comprising the step of specifying number of beneficiary subscribers for each of the predefined periodic intervals by the scheme moderator.

7. The computer implemented method of claim 1, wherein the scheme period is a ratio of the number of subscribers to the number of beneficiary subscribers for each of the predetermined periodic intervals.

8. The computer implemented method of claim 1, further comprising the steps of determining a subscription value for the scheme, wherein said subscription value is the ratio of the total face value to the number of subscribers.

9. The computer implemented method of claim 1, wherein said predetermined portion is calculated as the difference of the subscription value and the portion of the relinquished percentage distributed to each subscriber for the particular periodic interval.

10. The computer implemented method of claim 1, wherein said virtual financial community is formed by partnering with one of members of financial institutes, banks, cooperative and credit unions, professional clubs, employee social unions, home owner associations, common interest groups, online e-groups, and groups of people from industrial firms, organizations, and educational institutions.

11. A system for creating and maintaining a virtual financial community comprising a plurality of subscribers subscribing to social lending and/or borrowing schemes, said system comprising:
a scheme selector engine for specifying a total face value and a scheme period for said scheme;
a cycle calculator engine for specifying a number of predefined periodic intervals in said scheme period;
a profile engine for creating and maintaining subscriber profiles associated with said scheme;
a tracking engine for tracking the investments of each of the subscribers for each of the predefined periodic intervals;
a relinquishing and pooling engine for democratically electing a beneficiary subscriber to borrow an amount equal to the total face value at the end of each predefined periodic interval;
a reporting engine for reporting data on total investment amount and relinquished amount to the subscribers and a scheme moderator; and
a payment engine for distributing said amount relinquished by the beneficiary subscriber to the non beneficiary subscribers and the scheme moderator.

12. The system of claim 11, wherein a beneficiary subscriber is selected by democratically deciding the relinquish amount amongst the subscribers at the end of each predefined periodic interval using said relinquishing and pooling engine.

13. The system of claim 11, wherein said scheme selector engine specifies number of beneficiary subscribers for each of the predefined periodic intervals for said scheme.

14. The system of claim 11, wherein said cycle calculator engine calculates the scheme period as a ratio of the number of subscribers to the number of beneficiary subscribers for each of the predetermined periodic intervals.

15. The system of claim 11, wherein said scheme selector engine determines a subscription value for the scheme, wherein said subscription value is the ratio of a total face value of the scheme to the number of subscribers.

16. The system of claim 11, wherein said payment engine is used to release the borrowed amount to the beneficiary subscriber.
